(19) United States
(12) Patent Application Publication
(10) Pub. No.: US 2023/0311663 A1
(43) Pub. Date: Oct. 5, 2023

(54) DC CIRCUIT SWITCHING APPARATUS

(71) Applicants: AutoNetworks Technologies, Ltd., Yokkaichi, Mie (JP); Sumitomo Wiring Systems, Ltd., Yokkaichi, Mie (JP); Sumitomo Electric Industries, Ltd., Osaka-shi, Osaka (JP)

(72) Inventor: Yusuke ISAJI, Osaka-shi, Osaka (JP)

(21) Appl. No.: 18/006,657

(22) PCT Filed: Jul. 7, 2021
(86) PCT No.: PCT/JP2021/025586

§ 371 Date: Jan. 24, 2023

(30) Foreign Application Priority Data
Jul. 29, 2020 (JP) 2020-128228

(51) Int. Cl. B60L 3/00; H02H 7/20; B60L 3/04

(52) U.S. Cl. CPC B60L 3/0069; B60L 3/04; H02H 7/20

(57) ABSTRACT

A DC circuit switching apparatus having a novel structure is disclosed that can reduce the number of electromagnetic contactors with a simple structure, and can realize a compact and low-cost apparatus. A DC circuit switching apparatus to be connected between a battery and a load that includes a power supply line that connects between the battery and the load, wherein the power supply line includes a positive electrode-side power supply line and a negative electrode-side power supply line, a main relay is connected to one of the positive electrode-side power supply line and the negative electrode-side power supply line, and an active fuse is connected to the other of the positive electrode-side power supply line and the negative electrode-side power supply line.

### CROSS-REFERENCE TO RELATED APPLICATIONS

This application is the U.S. national stage of PCT/JP2021/025586 filed on Jul. 7, 2021, which claims priority of Japanese Patent Application No. JP 2020-128228 filed on Jul. 29, 2020, the contents of which are incorporated herein.

### TECHNICAL FIELD

The present disclosure relates to a DC circuit switching apparatus.

### BACKGROUND

In vehicles on which a high-voltage secondary battery is mounted such as an electric car and a hybrid vehicle, a DC circuit switching apparatus used for switching a high-voltage DC power supply circuit is mounted. In JP 2010-213500A, a configuration is disclosed in which a DC circuit switching apparatus is configured to include electromagnetic contactors (contactors) serving as main relays provided on a positive electrode side and a negative electrode side, and by turning off the two electromagnetic contactors, power supply from a secondary battery can be stopped.

However, in a DC circuit switching apparatus used for switching a high-voltage DC power supply circuit, large electromagnetic contactors having a special structure need to be provided on a positive electrode side and a negative electrode side, respectively, and therefore an increase in the cost and size of the apparatus is unavoidable. If an electromagnetic contactor is provided only on the positive electrode side, and the electromagnetic contactor on the negative electrode side is replaced with a thermal fuse, circuit breakage is performed utilizing heat. Therefore, circuit breakage cannot be performed using an external signal, and as a result, there is a risk that the circuit cannot be shut off even if an electrical leakage is detected.

Therefore, a DC circuit switching apparatus having a novel structure is disclosed that can reliably shut off power supply when an anomaly occurs, and with which a decrease in the size and cost of the apparatus can be advantageously realized.

### SUMMARY

A DC circuit switching apparatus of the present disclosure is a DC circuit switching apparatus to be connected between a battery and a load. The DC circuit switching apparatus includes: a power supply line including a positive electrode-side power supply line and a negative electrode-side power supply line that connect between the battery and the load; a main relay connected to one of the positive electrode-side power supply line and the negative electrode-side power supply line; and an active fuse that is connected to the other of the positive electrode-side power supply line and the negative electrode-side power supply line, and can be shut off by a control signal.

### Advantageous Effects

According to the present disclosure, a DC circuit switching apparatus having a novel structure can be provided that can reliably shut off power supply when an anomaly occurs, and with which a decrease in the size and cost of the apparatus can be advantageously realized.

### BRIEF DESCRIPTION OF DRAWINGS

FIG. 1 is a diagram schematically illustrating an electrical configuration, on a path from a battery to a load, of a DC circuit switching apparatus according to a first embodiment of the present disclosure.

FIG. 2 is a diagram schematically illustrating an electrical configuration, on a path from a battery to a load, of a DC circuit switching apparatus according to a second embodiment.

FIG. 3 is a diagram schematically illustrating an electrical configuration, on a path from a battery to a load, of a DC circuit switching apparatus according to a third embodiment.

FIG. 4 is a diagram schematically illustrating an electrical configuration, on a path from a battery to a load, of a DC circuit switching apparatus according to a fourth embodiment.

### DETAILED DESCRIPTION OF PREFERRED EMBODIMENTS

First, modes of the present disclosure will be enumerated and described.

### First Aspect

A DC circuit switching apparatus of the present disclosure is:

In accordance with a first aspect, a DC circuit switching apparatus to be connected between a battery and a load, including: a power supply line including a positive electrode-side power supply line and a negative electrode-side power supply line that connect between the battery and the load; a main relay connected to one of the positive electrode-side power supply line and the negative electrode-side power supply line; and an active fuse that is connected to the other of the positive electrode-side power supply line and the negative electrode-side power supply line, and can be shut off by a control signal.

According to the DC circuit switching apparatus of thefirst aspect, a main relay is connected to one of the positive electrode-side power supply line and the negative electrode-side power supply line, and an active fuse is connected to the other of the positive electrode-side power supply line and the negative electrode-side power supply line. Therefore, during normal travel, on/off control of the power supply line between the battery and the load can be performed by the main relay. When an anomaly such as a vehicle collision occurs, the power supply line can be reliably shut off by transmitting a control signal for instructing cutoff to the active fuse. Accordingly, when an anomaly occurs, the power supply can be reliably shut off, and the risk that electrical leakage or the like will occur can be advantageously reduced or prevented. Also, one main relay having a special structure that is expensive and large in size can be replaced with an active fuse that is inexpensive and small in size. Therefore, a reduction in the size and cost of the DC circuit switching apparatus can be advantageously realized.

Moreover, the main relay and the active fuse each need only be connected to one of the positive electrode-side power supply line and the negative electrode-side power supply line, and therefore, the freedom of arranging the main relay and the active fuse can be improved. As a result, the DC circuit switching apparatus can be made compact as a whole.

Note that, when maintenance or the like needs to be performed, by cutting the active fuse, the occurrence of a failure where a terminal portion provided on a power supply line on a side on which the active fuse is connected becomes an electrically active portion can be prevented.

### Second Aspect

In a second aspect, it is preferable that the main relay is connected to the positive electrode-side power supply line, and the active fuse is connected to the negative electrode-side power supply line. In this case as well, during normal travel, on/off control of the power supply line between the battery and the load can be reliably performed by the main relay connected to the positive electrode-side power supply line, and when an anomaly occurs, shutting off of the power supply line between the battery and the load can be reliably performed by the active fuse connected to the negative electrode-side power supply line. In particular, when a precharge circuit or the like is connected to the positive electrode-side power supply line, compact circuit routing or the like can be performed.

### Third Aspect

In a third aspect, it is preferable that the active fuse is connected to the positive electrode-side power supply line, and the main relay is connected to the negative electrode-side power supply line. In this case as well, during normal travel, on/off control of the power supply line between the battery and the load can be reliably performed by the main relay connected to the negative electrode-side power supply line, and when an anomaly occurs, shutting off of the power supply line between the battery and the load can be reliably performed by the active fuse connected to the positive electrode-side power supply line. Therefore, when it is difficult to secure a space for mounting a main relay on the positive electrode-side power supply line or the like as well, a main relay can be mounted on the negative electrode-side power supply line.

### Fourth Aspect

In a fourth aspect, it is preferable that a service plug is connected in series to the active fuse. Once an active fuse has been used for shutting off the power supply line, the active fuse is destroyed, and therefore cannot be re-used, and a new active fuse is needed. As a result of connecting a service plug in series to the active fuse, the power supply line can be shut off by the service plug. Therefore, there is no need to cut an active fuse in order to shut off power supply from the battery when maintenance is performed or the like, and to replace the cutoff active fuse with a new active fuse, and the cost can be reduced. Note that the service plug is a plug for shutting off the power supply line and safely performing work, when maintenance of a portion to which a high voltage is applied or through which a large current flows is performed, and the service plug is invariably disconnected when the battery is being replaced.

### Fifth Aspect

In a fifth aspect, it is preferable that the active fuse is a pyro-fuse. This is because, since the active fuse is constituted by a pyro-fuse, the power supply line between the battery and the main relay can be instantaneously and reliably shut off by explosive power generated by igniting an explosive.

Specific examples of the DC circuit switching apparatus of the present disclosure will be described below with reference to the drawings. Note that the present disclosure is not limited to these illustrative examples and is defined by the claims, and all changes that come within the meaning and range of equivalency of the claims are intended to be embraced therein.

### First Embodiment

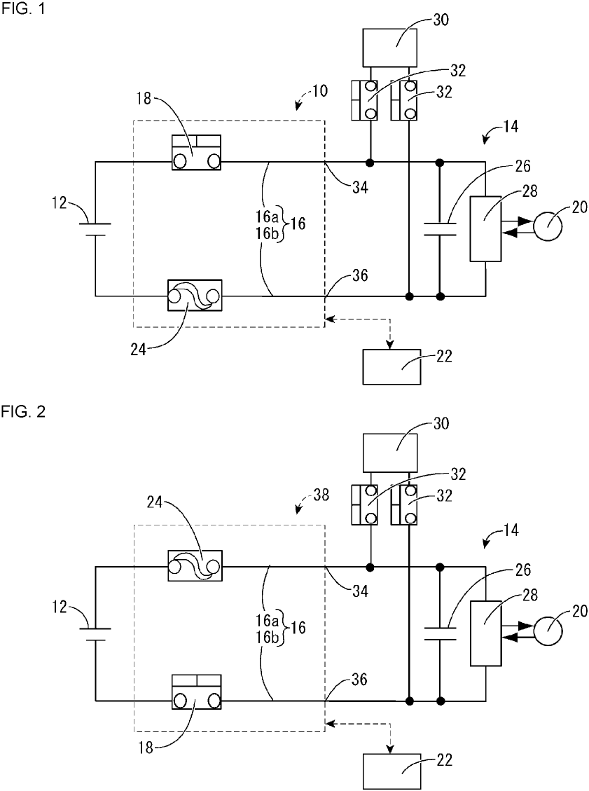

A DC circuit switching apparatus 10 of a first embodiment of the present disclosure will be described below with reference to FIG. 1. The DC circuit switching apparatus 10 is mounted on a vehicle (not shown) such as an electric car or a hybrid car, for example. The DC circuit switching apparatus 10 is connected between a battery 12 and a load 14, as shown in FIG. 1. The DC circuit switching apparatus 10 includes a power supply line 16 that connects between the battery 12 and the load 14. The power supply line 16 includes a positive electrode-side power supply line 16a and a negative electrode-side power supply line 16b. A main relay 18 is connected to the positive electrode-side power supply line 16a, and a pyro-fuse 24, which is an active fuse, is connected to the negative electrode-side power supply line 16b.

Power is supplied to a motor 20, which causes the vehicle to run and constitutes the load 14, from the battery 12 via the main relay 18 and the pyro-fuse 24. Here, the main relay 18 is a mechanical relay including a relay such as a contactor, which is used for a high-voltage or large-current load 14 or a high-voltage and large-current load 14. Also, on/off control is performed based on a control signal from a vehicle control unit 22 that includes an ECU and the like. Also, the pyro-fuse 24 can be cut based on a control signal from the vehicle control unit 22. When the main relay 18 is on, the battery 12 and the motor 20 are connected, and power is supplied to the motor 20. When the main relay 18 is off and the pyro-fuse 24 is cut, a current flowing between the battery 12 and the motor 20 is shut off, and power supply to the motor 20 is stopped. Note that reference numerals may be given to only some of a plurality of the same members, and omitted from the other members.

### Battery 12

The output voltage of the battery 12 is increased to a voltage in a range from 100 V to 400 V, for example, by connecting a plurality of chargeable secondary batteries in series. Also, the current capacity can also be increased by connecting a plurality of secondary batteries in parallel. A lithium ion secondary battery, a lithium polymer secondary battery, a nickel hydrogen battery, and the like can be used as this secondary battery. Also, a capacitor such as an electric double-layer capacitor (EDLC) can also be used in place of or in addition to the secondary battery. In this specification, secondary batteries also include capacitors.

### Load 14

As shown in FIG. 1, the load 14 includes a large capacitance capacitor 26 and a DC/AC inverter 28 that are connected in parallel, for example. Here, the load 14 connects the battery 12 to the motor 20 via the DC/AC inverter 28. The DC/AC inverter 28 converts a DC voltage of the battery 12 to an AC voltage and supplies the resultant AC voltage to the motor 20. Note that, when the motor 20 performs regenerative braking, the motor 20 acts as a generator and charges the battery 12. The DC/AC inverter 28 is used in the first embodiment of the present disclosure, but a DC/DC converter may also be used.

### Pyro-Fuse 24

The pyro-fuse 24 is an active fuse. Here, an active fuse refers to an element that can be cut based on a control signal from an external device. Specifically, the pyro-fuse 24 can be cut based on a control signal from the vehicle control unit 22 that includes an ECU and the like when an anomaly is detected in the DC circuit switching apparatus 10.

### Fast-Charging Power Supply 30

As shown in FIG. 1, a fast-charging power supply 30 is connected in parallel to the DC circuit switching apparatus 10 on an output side thereof via relays 32, 32. Accordingly, fast charging of the high-voltage battery 12 can be performed by turning on the relays 32, 32 and connecting, at a charging station or the like, a high-voltage DC power supply to the fast-charging power supply 30 while the motor 20 is stopped and the main relay 18 is turned on.

Next, operations of the DC circuit switching apparatus 10 of the first embodiment of the present disclosure will be briefly described. In the first embodiment of the present disclosure, when power supply is started, initially, the battery 12 and the motor 20 are connected, and power can be supplied to the motor 20. Note that, in the following description, this state is referred to as a “normal state” as appropriate. In the normal state, on/off control of the power supply line 16 between the battery 12 and the load 14 can be performed by the main relay 18.

The power supply line 16 of the DC circuit switching apparatus 10 is provided with a current sensor and a voltage sensor, which are not illustrated, for example, and in the normal state, a current value of the current sensor and a voltage value of the voltage sensor are transmitted to the vehicle control unit 22. If it is determined that the current value or the voltage value is anomalous (e.g., a value exceeding stipulated values) in the vehicle control unit 22, the vehicle control unit 22 transmits control signals to the main relay 18 and the pyro-fuse 24. Accordingly, the main relay 18 is turned off and the pyro-fuse 24 is cut, and both of the positive electrode-side power supply line 16a and the negative electrode-side power supply line 16b of the power supply line 16 are reliably shut off Moreover, the pyro-fuse 24 is constituted by an active fuse, and therefore the power supply line 16 between the battery 12 and the main relay 18 can be instantaneously and reliably shut off by explosive power generated by igniting an explosive.

According to the DC circuit switching apparatus 10 of the present disclosure that is configured as described above, the main relay 18 is connected to the positive electrode-side power supply line 16a and the pyro-fuse 24 is connected to the negative electrode-side power supply line 16b. In the normal state, on/off control of the power supply line 16 between the battery 12 and the load 14 can be performed by the main relay 18. In an abnormal state such as a state of vehicle collision, the vehicle control unit 22 transmits control signals to the main relay 18 and the pyro-fuse 24, and the main relay 18 is turned off and the pyro-fuse 24 is cut. Accordingly, the power supply line 16 can be reliably shut off. Therefore, the power supply can be reliably shut off when an anomaly occurs, and the risk that electrical leakage or the like will occur can be advantageously reduced or prevented. Moreover, one main relay 18 having a special structure that is expensive and large in size (a main relay conventionally connected to the negative electrode-side power supply line, in the first embodiment) can be replaced with a pyro-fuse 24 that is inexpensive and small in size. Therefore, a reduction in the size and cost of the DC circuit switching apparatus 10 can be advantageously realized. In particular, when a precharge circuit and the like are connected to the positive electrode-side power supply line 16a, compact circuit routing or the like can be performed.

Also, when maintenance or the like needs to be performed, the vehicle control unit 22 transmits control signals to the main relay 18 and the pyro-fuse 24, and the main relay 18 is turned off and the pyro-fuse 24 is cut. Accordingly, a voltage is not applied to a terminal portion of the positive electrode-side power supply line 16a (a terminal portion 34 on the load 14 side of the positive electrode-side power supply line 16a, in the first embodiment), and the occurrence of a failure where the terminal portion becomes an electrically active portion can be prevented. In addition, a voltage is also not applied to a terminal portion of the negative electrode-side power supply line 16b (a terminal portion 36 on the load 14 side of the negative electrode-side power supply line 16b, in the first embodiment), and the occurrence of a failure where the terminal portion becomes an electrically active portion can also be prevented.

### Other Embodiments

As described above, the first embodiment has been described in detail, as a specific example of the present disclosure, but the present disclosure is not limited to this specific description. Modifications and improvements in a range in which the object of the present disclosure can be achieved are included in the present disclosure. Embodiments such as the following, for example, are also included in the technical scope of the present disclosure.

(1) In the above first embodiment, the DC circuit switching apparatus 10 in which the main relay 18 is connected to the positive electrode-side power supply line 16a and the pyro-fuse 24 is connected to the negative electrode-side power supply line 16b has been described as an example, but there is no limitation to this. For example, as in a DC circuit switching apparatus 38 of a second embodiment shown in FIG. 2, a pyro-fuse 24 may be connected to a positive electrode-side power supply line 16a, and a main relay 18 may be connected to a negative electrode-side power supply line 16b. In this case as well, on/off control of the negative electrode-side power supply line 16b between a battery 12 and a load 14 can be performed using the main relay 18, similarly to the above first embodiment. Moreover, the positive electrode-side power supply line 16a between the battery 12 and the load 14 can be reliably shut off by transmitting a control signal to the pyro-fuse 24. Therefore, one main relay 18 that is expensive and large in size (a main relay conventionally connected to the positive electrode-side power supply line, in the second embodiment) can be replaced with a pyro-fuse 24 that is inexpensive and small in size. Therefore, a reduction in the size and cost of the 38 can be reduced. Also, when it is difficult to secure a space for mounting a main relay 18 on the positive electrode-side power supply line 16a or the like as well, a main relay 18 can be mounted on the negative electrode-side power supply line 16b.

Moreover, when maintenance or the like needs to be performed, the vehicle control unit 22 transmits control signals to the main relay 18 and the pyro-fuse 24, and the main relay 18 is turned off and the pyro-fuse 24 is cut. Accordingly, a voltage is not applied to a terminal portion of the negative electrode-side power supply line 16b (a terminal portion 36 on the load 14 side of the negative electrode-side power supply line 16b, in the second embodiment), and the occurrence of a failure where the terminal portion becomes an electrically active portion can be prevented. In addition, a voltage is also not applied to a terminal portion of the positive electrode-side power supply line 16a (a terminal portion 34 on the load 14 side of the positive electrode-side power supply line 16a, in the second embodiment), and the occurrence of a failure where the terminal portion becomes an electrically active portion can also be prevented. As shown in the above first embodiment and the above second embodiment, the main relay 18 and the pyro-fuse 24 need only be connected to one of the positive electrode-side power supply line 16a and the negative electrode-side power supply line 16b. Therefore, the freedom of arranging the main relay 18 and the pyro-fuse 24 can be improved. As a result, the DC circuit switching apparatus 10, 38 can be made compact as a whole.

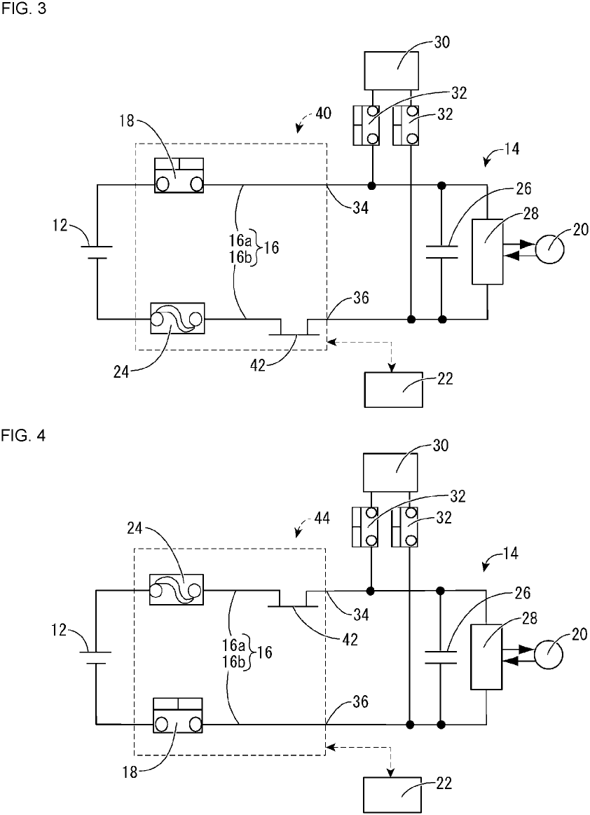

(2) Also, as in a DC circuit switching apparatus 40 of a third embodiment shown in FIG. 3, a service plug 42 may also be connected in series to a pyro-fuse 24. In the first and second embodiments described above, once the pyro-fuse 24 is used for shutting off the power supply line, the pyro-fuse 24 is destroyed, and therefore cannot be re-used, and a new pyro-fuse 24 is required. Therefore, by connecting the service plug 42 in series to the pyro-fuse 24, as in the DC circuit switching apparatus 40 of the third embodiment, the power supply line 16 can be shut off by the service plug 42. As a result, the pyro-fuse 24 need not be replaced, and the cost can be reduced. Note that the service plug 42 is a plug for shutting off the power supply line 16 and safely performing work, when maintenance of a portion to which a high voltage is applied or through which a large current flows is performed, and the service plug 42 invariably is disconnected when the battery 12 is being replaced. In the third embodiment as well, similarly to the first and second embodiments described above, one main relay 18 that is expensive and large in size can be replaced with a pyro-fuse 24 that is inexpensive and small in size. Therefore, the size and the cost of the DC circuit switching apparatus 40 can be reduced.

(3) Furthermore, as in a DC circuit switching apparatus 44 of the fourth embodiment shown in FIG. 4, a service plug 42 may also be connected in series to a pyro-fuse 24, in a positive electrode-side power supply line 16a. In this case as well, it is apparent that the same effect as the DC circuit switching apparatus 40 of the above third embodiment is achieved.

1. A DC circuit switching apparatus to be connected between a battery and a load, comprising:
a power supply line including a positive electrode-side power supply line and a negative electrode-side power supply line that connect between the battery and the load;
a main relay connected to one of the positive electrode-side power supply line and the negative electrode-side power supply line; and
an active fuse that is connected to the other of the positive electrode-side power supply line and the negative electrode-side power supply line, and can be shut off by a control signal.

2. The DC circuit switching apparatus according to claim 1, wherein the main relay is connected to the positive electrode-side power supply line, and the active fuse is connected to the negative electrode-side power supply line.

3. The DC circuit switching apparatus according to claim 1, wherein the active fuse is connected to the positive electrode-side power supply line, and the main relay is connected to the negative electrode-side power supply line.

4. The DC circuit switching apparatus according to claim 1, wherein a service plug is connected in series to the active fuse.

5. The DC circuit switching apparatus according to claim 1, wherein the active fuse is a pyro-fuse.

6. The DC circuit switching apparatus according to claim 2, wherein a service plug is connected in series to the active fuse.

7. The DC circuit switching apparatus according to claim 3, wherein a service plug is connected in series to the active fuse.

8. The DC circuit switching apparatus according to claim 2, wherein the active fuse is a pyro-fuse.

9. The DC circuit switching apparatus according to claim 3, wherein the active fuse is a pyro-fuse.

10. The DC circuit switching apparatus according to claim 4, wherein the active fuse is a pyro-fuse.
